(19) United States
(12) Patent Application Publication
(10) Pub. No.: US 2016/0100238 A1
(43) Pub. Date: Apr. 7, 2016

(54) RUGGEDIZER FOR COMMUNICATIONS HEADSET

(71) Applicant: Sonetics Holdings, Inc., Portland, OR (US)

(72) Inventors: Simon Broadley, West Linn, OR (US); Brian VanderPloeg, Lake Oswego (AZ); Calvin Toothaker, Portland, AZ (US)

(21) Appl. No.: 14/967,284

(22) Filed: Dec. 12, 2015

Related U.S. Application Data
(63) Continuation-in-part of application No. 14/322,069, filed on Jul. 2, 2014.

(51) Int. Cl. H04R 1/10

(52) U.S. Cl. CPC H04R 1/1008; H04R 1/1066; H04R 2201/107

(57) ABSTRACT

A flexible and resilient covering, or ruggedizer, for an ear cup of a communications headset that provides noise reduction, additional water resistance, additional dust resistance, flotation of the entire headset, and improved mechanical shock resistance. The ruggedizer is preferably made of silicone rubber. Additionally, the ruggedizer may be made in various bright colors, each corresponding to a sub net of the communications network in which the headset is used, to make for easy identification of the headset's purpose. The ruggedizer has openings for headgear couplings, such as a head strap, a DC charging port, forward-facing microphone, an indicator light, and a base for a boom microphone. The ruggedizer has conformal portions over buttons and switches. The internal surface of the ruggedizer may be grooved to indicate cutting lines for adding optional equipment connections. Ruggedizers are preferably provided pairs (left and right) that are not identical.

### CROSS REFERENCE TO RELATED APPLICATIONS

This application is a continuation in part of U.S. patent application Ser. No. 14/322,069 filed 2 Jul. 2014, by at least on common inventor, the entire disclosure of which is herein incorporated by reference.

### FIELD OF ART

The present invention relates to customized resilient outer coverings for the ear cups of communication headsets. More particularly, the invention relates to a preferably silicone rubber cover for the ear cups of communication headsets.

### STATEMENT REGARDING FEDERALLY SPONSORED RESEARCH AND DEVELOPMENT

None.

### BACKGROUND OF THE INVENTION

Headsets are widely used in industry for hearing protection, electronic communication, or both. A headset consists of one or two earpieces that cover the ear or ears of the user, and a headband that couples to the earpiece or earpieces to provide support for the ear piece or earpieces. An earpiece includes an ear cup that supports electronics, manual controls, access points, a head cushion that surrounds the ear when in use, and one or more portions of couplings for headbands. With the advancement of communications technology, such as DECT 7 compliant technology, large numbers of people can be connected to a single communication headset network with subsets of users having particular communications relationship within their subset. In order to organize the headset equipment that has been set for a particular subset of the network, or sub net, bothersome controls on stowing and deploying headsets may be established.

Headsets for emergency crews, for example at sea, can be lost in the water and sink beyond recovery. Headsets are also vulnerable to shock from being dropped on hard surfaces.

Accordingly, there is a need for a ruggedizer that can ease the sorting of headsets for complex communication headset networks, improve shock resistance, improve water resistance, provide visual identification of sub net during use, and provide flotation for headsets.

### SUMMARY OF THE INVENTION

In one embodiment, the invention provides a pair of (preferably) brightly colored silicone rubber covers for respective ear cups of a headset to provide identification of subsets of a communication network by color and further provide flotation for the entire headset, noise reduction, improved water resistance, improved dust resistance, and improved shock resistance. The covers have openings corresponding to access points on the ear cup

### DESCRIPTION OF THE FIGURES OF THE DRAWINGS

The present invention will hereinafter be described in conjunction with the following drawing figures, wherein like numerals denote like elements, and

FIG. 1 is a perspective view illustrating an exemplary embodiment of the ruggedizers installed on a headset in a first exemplary configuration, according to a preferred embodiment of the present invention;

FIG. 2 is a front elevation view illustrating the exemplary embodiment of the ruggedizers installed on a headset of FIG. 1 in the first exemplary configuration, according to a preferred embodiment of the present invention;

FIG. 3 is a left side elevation view illustrating an exemplary embodiment of the ruggedizers installed on a headset of FIG. 1 in the first exemplary configuration, according to a preferred embodiment of the present invention;

FIG. 4 is a right side elevation view illustrating the exemplary embodiment of the ruggedizers installed on a headset of FIG. 1 in the first exemplary configuration, according to a preferred embodiment of the present invention;

FIG. 5 is a top plan view illustrating the exemplary embodiment of the ruggedizers installed on a headset of FIG. 1 in the first exemplary configuration, according to a preferred embodiment of the present invention;

FIG. 6 is a side elevation view illustrating an exemplary embodiment of a ruggedizer being removed from a right ear cup of the headset of FIG. 1, according to a preferred embodiment of the present invention;

FIG. 7 is a side elevation view illustrating an exemplary embodiment of a ruggedizer being placed over a right ear cup of the headset of FIG. 1, according to a preferred embodiment of the present invention;

FIG. 8 is a perspective view illustrating an exemplary embodiment of a step of a method of head strap attachment to the right ear cup of the headset of FIG. 1, according to a preferred embodiment of the present invention;

FIG. 9 is a perspective view illustrating an exemplary embodiment of a further step of a method of head strap attachment to the right ear cup of the headset of FIG. 1, according to a preferred embodiment of the present invention;

FIG. 10 is a side elevation view illustrating the ruggedizer for the right-side ear cup of the headset of FIG. 1, according to a preferred embodiment of the present invention; and

FIG. 11 is a bottom plan view illustrating the ruggedizer for the right-side ear cup of the headset of FIG. 1, according to a preferred embodiment of the present invention.

### DETAILED DESCRIPTION OF THE INVENTION

As used and defined herein, the term “headset” refers to a communications headset that consists of one or two earpieces that cover the ear or ears of the user, and a headband that couples to the earpiece or earpieces to provide support for the ear piece or earpieces. An earpiece is defined to include an ear cup that supports electronics, manual controls, access points, a head cushion that surrounds the ear when in use, and one or more portions of couplings for headbands.

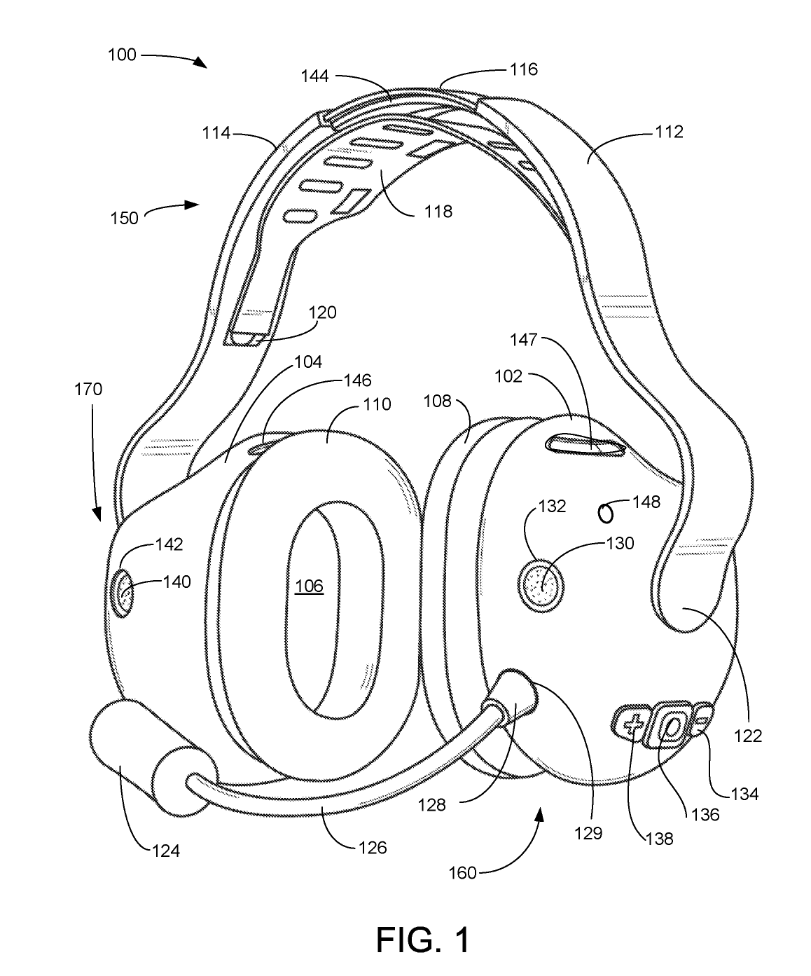

FIG. 1 is a perspective view illustrating an exemplary embodiment of ruggedizers 102 and 104 installed on a headset 100, according to a preferred embodiment of the present invention. The headset 100 includes headgear 150, left side communication earpiece 160, and right side communication earpiece 170. Each earpiece 160 and 170 includes a structural ear cup 106 that fits over the users ear (one visible in this view), a head cushion 108 and 110, respectively extending from the open edge of each ear cup 106, and communications electronics and controls, about which more will be described below. Each earpiece 160 and 170 has a ruggedizer 102 and 104, respectively. Each ruggedizer 102 and 104 comprises a flexible resilient cover for each ear cup 106. As earpiece 160 is not the same as earpiece 170, so the ruggedizers 102 and 104, respectively, are not identical. Ruggedizers 102 and 104 share some features. Both are made of a flexible resilient material, preferably silicone rubber, shaped adaptively to an exterior surface of an ear cup 106, including protrusions such as buttons and switches. Both rugggedizers 102 and 104 have openings for direct access to access points, such as a DC charging port 406, an indicator light opening 148, a strap slot 146 or 147, or a cup-mounted microphone 140 on the exterior surfaces of their respective ear cups 106. Both rugggedizers 102 and 104 have conformal portions that fit to cover manually activated controls on their respective earpieces 160 and 170 for manual access, through the flexible ruggedizer, to controls on the exterior surfaces of their respective ear cups 106. Preferably, rugggedizers 102 and 104 are water resistant.

Both rugggedizers 102 and 104 are preferably the same color. Bright colors are preferred, but black and white are also options. In a particular embodiment, both rugggedizers 102 and 104 have glow-in-the-dark coloration. In yet another particular embodiment, both rugggedizers 102 and 104 are translucent, and are illuminated by electric lights, such as, without limitation, LEDs, sandwiched between each ear cup 106 and each respective ruggedizer 102 and 104. In a particular embodiment, left ruggedizer 102 may have a first color and right ruggedizer 104 may have a second color, to assist others in determining the orientation of the user in low visibility conditions. In a particular embodiment, each ruggedizer 102 and 104 may have more than one color to further assist others in determining the orientation of the user in low visibility conditions.

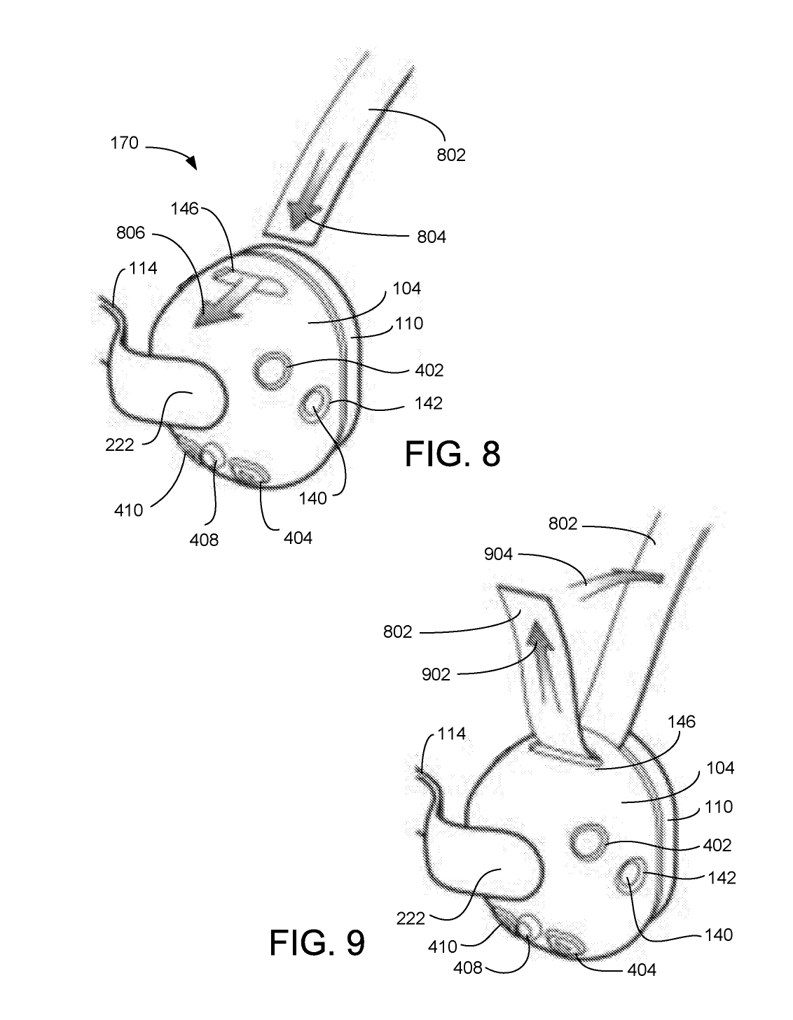

Left ruggedizer 102 has a microphone opening 132 for forward-directed microphone 130 and has a boom opening 129 for the base 128 of a boom 126 for boom microphone 124. Left ruggedizer 102 also has a strap opening 147 for use with a head strap 802 (see FIG. 8), which strap 802 is used when the headgear 150 is rotated backward, relative to the earpieces 160 and 170, to a position behind the user's head. Left ruggedizer 102 also has an indicator light opening 148 to provide visibility for a status indicator light, such as, without limitation, an LED. Lastly, hidden in this view, left ruggedizer 102 has a headgear opening 1104 (see FIG. 11) for receiving a coupling between the headgear, at tip 122, and the ear cup 106. Left ruggedizer 102 has conformal portions 134, 136, and 138 covering controls that are manually operated by the user. For example, conformal portion 134 may cover a volume lowering control, conformal portion 136 may cover an answer/menu button, and conformal portion 138 may cover a volume raising button. All of the manually activated controls under conformal portions 134, 136, and 138 can be operated by pressing through the ruggedizer 102. The conformal portions 134, 136, and 138 recreate the tactile features of their respective controls for ease of use. Right ruggedizer 104 has an opening 142 for forward-directed microphone 140 and has a strap opening 146 similar to strap opening 147. It should be appreciated that the openings described are merely exemplary, and that more, fewer, or different openings 129, 132, 142, 146, 147, and 148 and/or more, fewer, or different conformal portions 134, 136, and 138 may be used in various additional embodiments.

Ruggedizers 102 and 104 provide the following advantages to headset 100: improved mechanical shock resistance, improved water resistance, improved dust resistance, improved visibility to others, visual sub net identification, flotation of the entire headset, and noise reduction.

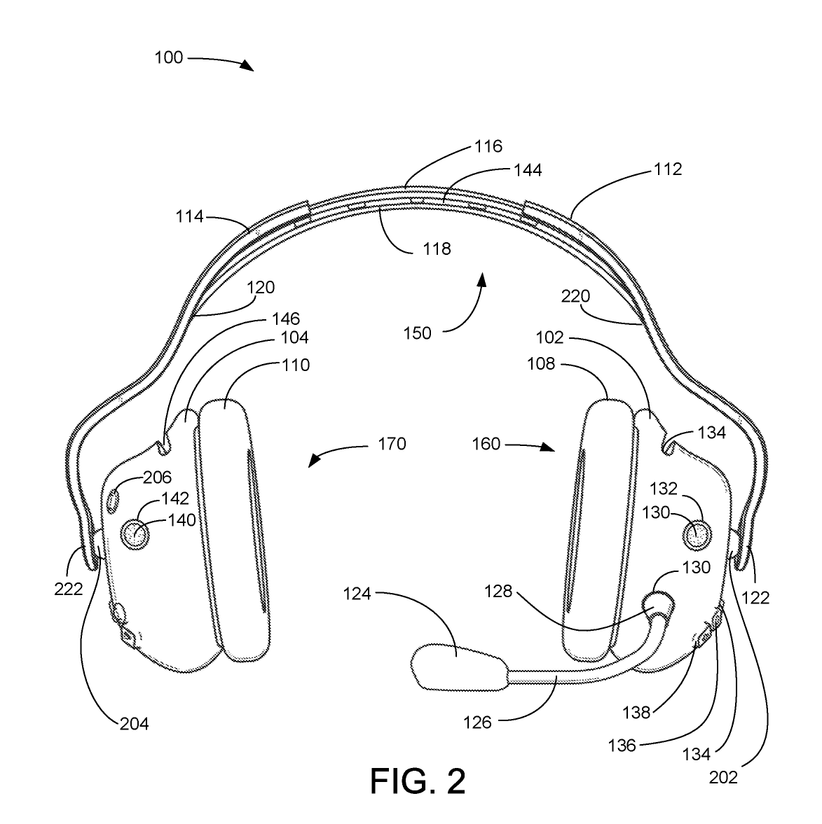

Headgear 150 includes head band sections 112 and 114 coupled together by head band adjuster 116. Head band sections 112 and 114 support head protector 118 at couplings 120 and 220 (see FIG. 2). Cable support 144 is supported by head band sections 112 and 114. Head band sections 112 and 114 couple at tips 122 and 222 (see FIG. 2) to earpieces 160 and 170, respectively. In additional embodiments, ear cups 106 may have various shapes and ruggedizers 102 and 104 may be produced adaptive to such various shapes. Ear cups 106 have sealed air chambers within to assist in providing flotation. The weight and volume of the ruggedizers 102 and 104 must be selected to not overbear the flotation provided by the sealed air chambers.

FIG. 2 is a front elevation view illustrating the exemplary embodiment of the ruggedizers 102 and 104 installed on a headset 100 of FIG. 1, according to a preferred embodiment of the present invention. Additional conformal portions 206 can be seen in this view, as well as ball portions 202 and 204 extending from head band sections 112 and 114, respectively, into sockets in earpieces 160 and 170, respectively. The headgear couplings using ball portions 202 and 204 are illustrated in the embodiment of FIG. 1 as being a ball and socket joint, but the invention is not so limited.

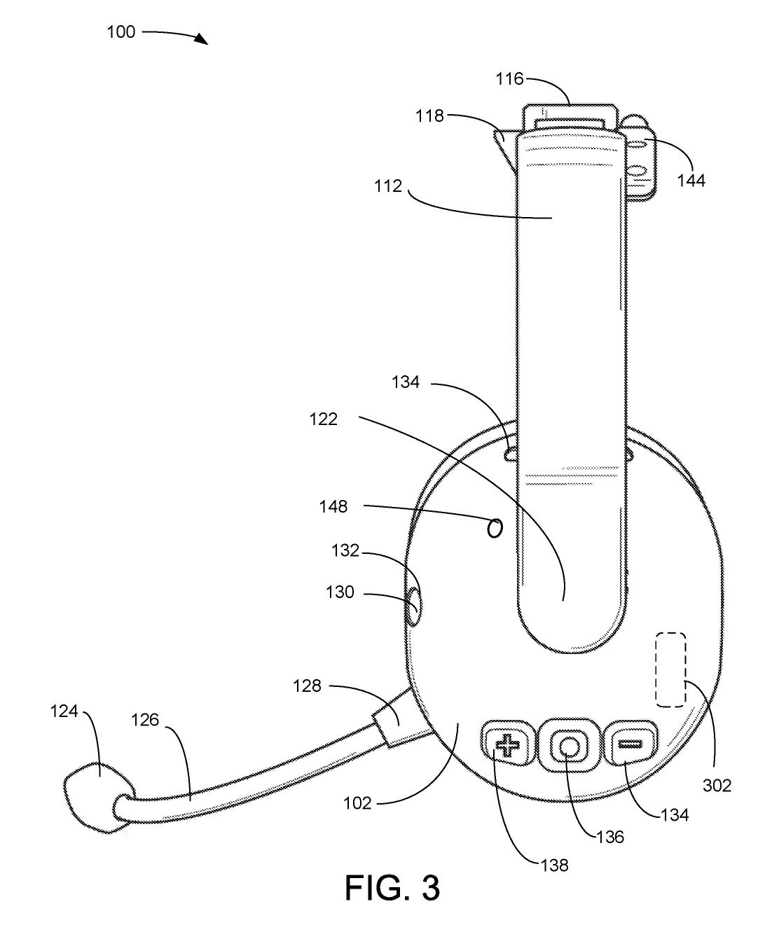

FIG. 3 is a left side elevation view illustrating an exemplary embodiment of the left ruggedizer 102 installed on a headset of FIG. 1, according to a preferred embodiment of the present invention. Groove 302 is a groove on the internal surface of the ruggedizer 102 that aligns to a two-way radio port opening on the external surface of the ear cup 106. Should the user desire to connect a two-way radio to the headset 100, the user can cut along groove 302 to gain access to the port. In other embodiments, other groves may be provided for other optional connections. In additional embodiments, various configurations of openings and conformal portions may adapt to corresponding configurations of access points and controls on the ear cup 106.

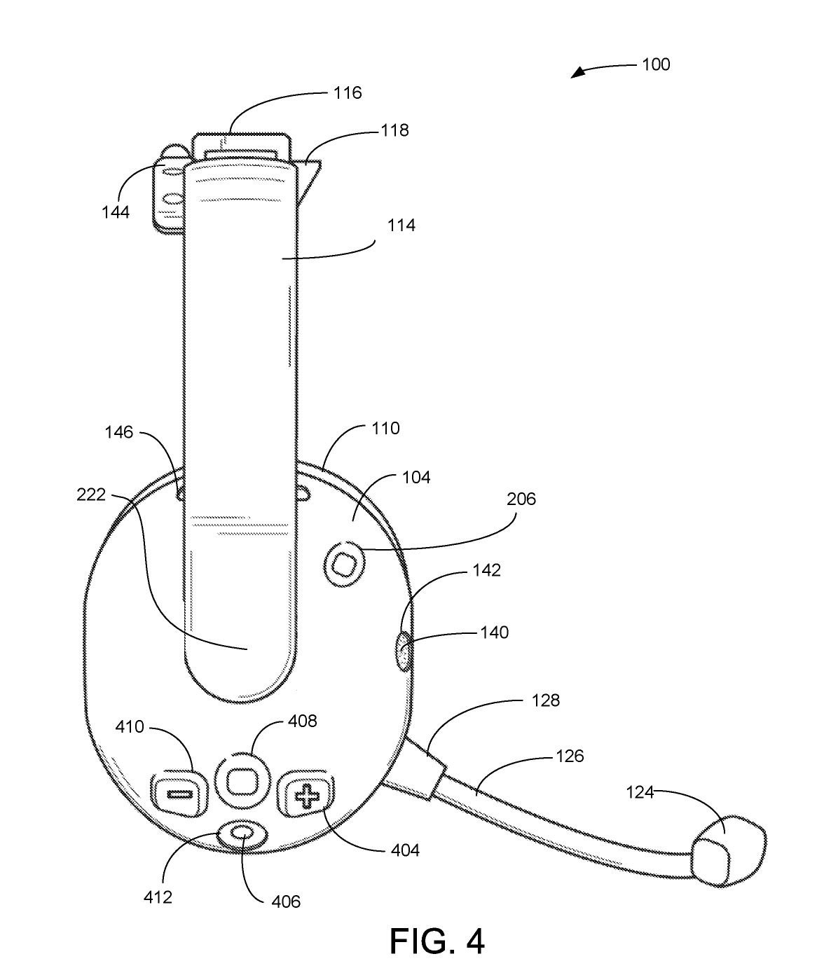

FIG. 4 is a right side elevation view illustrating the exemplary embodiment of the ruggedizer 104 installed on a headset of FIG. 1, according to a preferred embodiment of the present invention. A power button conformal portion 206 of the ruggedizer 104 allows the user to manually actuate the power ON/OFF toggle button through the flexible and resilient ruggedizer 104. Power jack opening 412 in ruggedizer 104 enables access to DC power jack 406 for providing direct power and for recharging the internal battery. A push-to-talk (PTT) button conformal portion 408 of the ruggedizer 104 allows the user to manually actuate the PTT through the flexible and resilient ruggedizer 104. Down-channel selector switch conformal portion 410 of ruggedizer 104 allows the user to manually actuate the down-channel selector switch through the flexible and resilient ruggedizer 104. Up-channel selector switch conformal portion 404 of ruggedizer 104 allows the user to manually actuate the up-channel selector switch through the flexible and resilient ruggedizer 104. In additional embodiments, various configurations of openings and conformal portions may adapt to corresponding configurations of access points and controls on the ear cup 106.

FIG. 5 is a top plan view illustrating the exemplary embodiment of the ruggedizers 102 and 104 installed on a headset 100 of FIG. 1, according to a preferred embodiment of the present invention. Cable threading bores 502 (one of five labeled) in cable support 144 enable, in particular embodiments, a cable connection between earpieces 160 and 170. The cable is threaded through two or more of cable threading bores 502 to maintain control of cable to move with headgear 150. In various other embodiments, more or fewer cable threading bores may be used. In various additional embodiments, cable threading bores 502 may have various cross-sectional shapes.

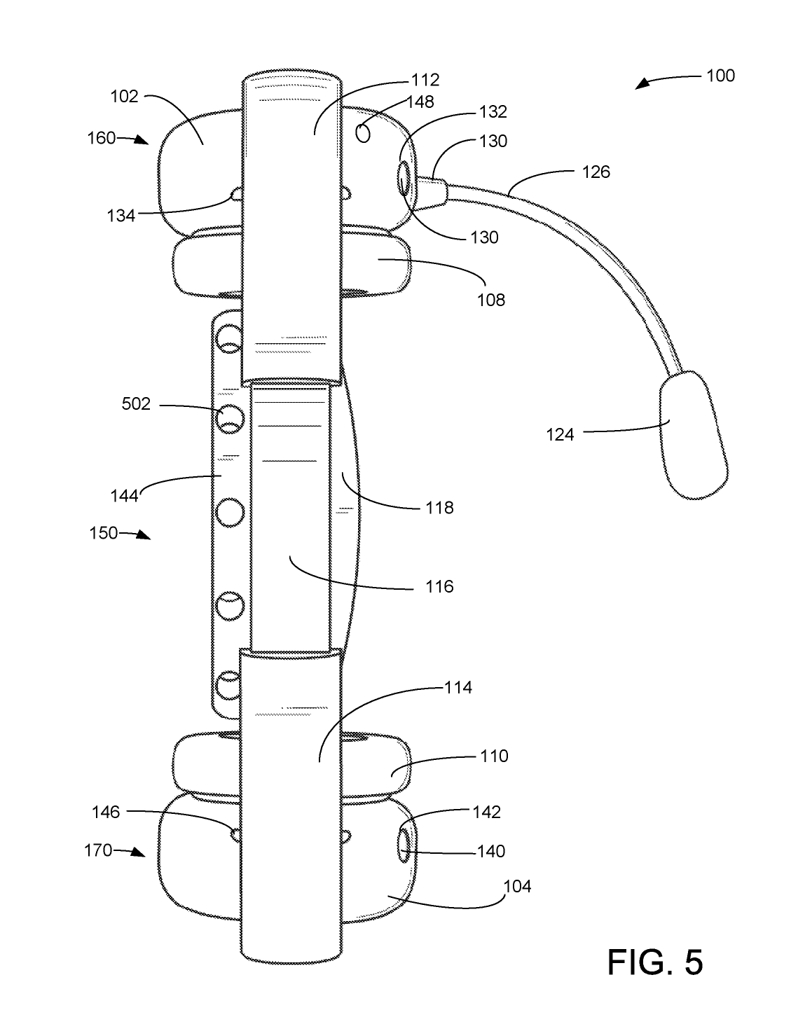

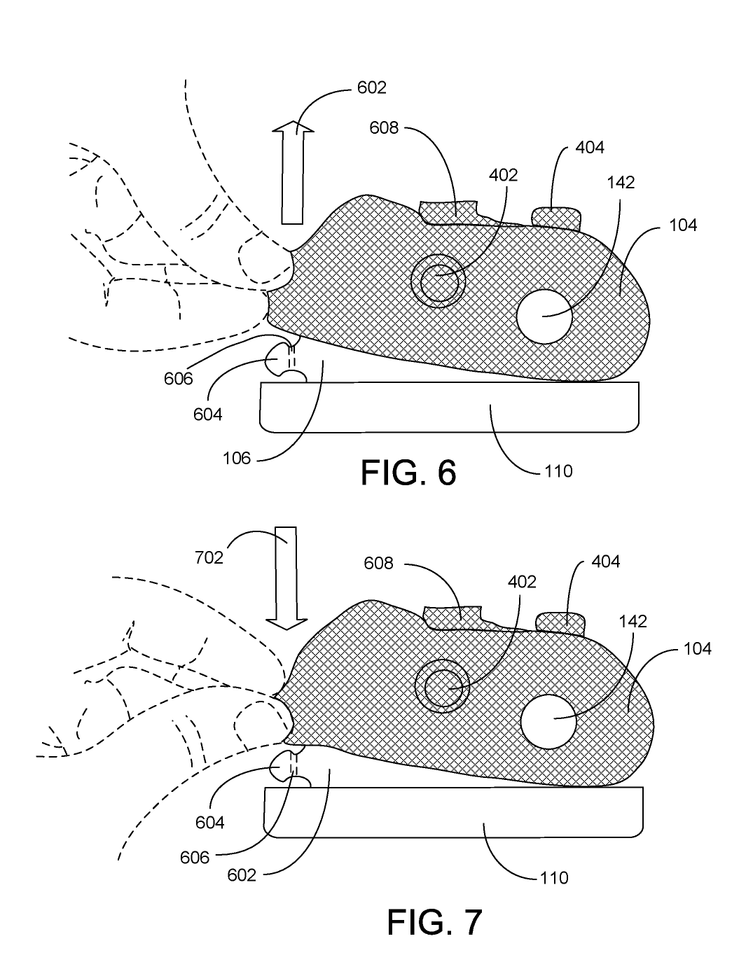

FIG. 6 is a side elevation view illustrating an exemplary embodiment of a ruggedizer 104 being removed from a right ear cup 106 of the headset 100 of FIG. 1, according to a preferred embodiment of the present invention. The ruggedizer 104 may be manually removed 602 from the ear cup 106 for any purpose. Non-limiting examples of such purposes include: modification as discussed in regard to FIG. 3, replacement, or to make head strap threading easier. The ear cup 106 has a lip 604, at least on the top edge of the ear cup 106, which includes head band slot 606. The clearance between the lip 604 and the head cushion 110 provides room for threading a head strap 802 (see FIG. 8) through head strap slot 606 and head strap opening 146 of the ruggedizer 104. In order to remove the ruggedizer 104, the headgear 150 must be disconnected from the earpiece 170. Collar 608 of ruggedizer 104 surrounds the ear cup socket of the ball and socket coupling and is shown here distorted by the flexing of the ruggedizer 104 as it is manipulated. In another embodiment, the collar 608 may be omitted. The method of removal of ruggedizer 104 is similar for ruggedizer 102.

FIG. 7 is a side elevation view illustrating an exemplary embodiment of a ruggedizer 104 being placed over a right ear cup 106 of the headset 100 of FIG. 1, according to a preferred embodiment of the present invention. The ruggedizer 104 may be manually installed 702 on ear cup 106 for any purpose. In order to install the ruggedizer 104, the headgear 150 must be disconnected from the earpiece 170. When fully installed, a conformal inwardly turned edge 1102 (see FIG. 11) of the ruggedizer 104 fits between the lip 604 and the head cushion 110, but not so much as to interfere with the head band slot 606. The method of installation of ruggedizer 104 is similar for ruggedizer 102.

FIG. 8 is a perspective view illustrating an exemplary embodiment of a step of a method of head strap 802 attachment to the right earpiece 170 of the headset 100 of FIG. 1, according to a preferred embodiment of the present invention. Head strap 802 is threaded 804 towards a position under lip 604, toward head strap slot 606 and toward 806 head strap opening 146 of the ruggedizer 104. The head strap 802 is used when head band section 114 is orientated towards the rear of the user's head, and vertical support for the weight of the earpiece 170 is required. Head strap 802 may be made of various flexible, comfortable, materials and preferably has hook and loop fasteners.

FIG. 9 is a perspective view illustrating an exemplary embodiment of a further step of a method of head strap attachment to the right ear cup of the headset of FIG. 1, according to a preferred embodiment of the present invention. Head strap 802 is threaded under lip 604, through head strap slot 606 and through 902 head strap opening 146 of the ruggedizer 104. A hook and loop end of head strap 802 is then engaged 904 with a hook and loop portion of head strap 802 to secure the head strap 802 in place. The head strap 802 is used when head band section 114 is orientated towards the rear of the user's head, and vertical support for the weight of the earpiece 170 is required.

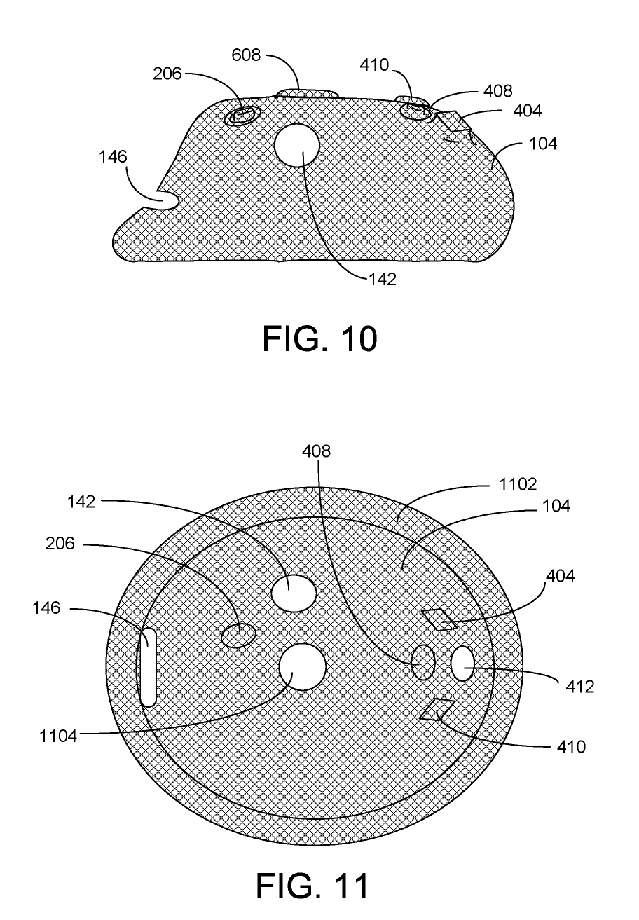

FIG. 10 is a side elevation view illustrating the ruggedizer 104 for the right-side ear cup 106 of the headset 100 of FIG. 1, according to a preferred embodiment of the present invention. The ruggedizers 102 and 104 have sufficient structural integrity to stand on their own.

FIG. 11 is a bottom plan view illustrating the ruggedizer for the right-side ear cup of the headset of FIG. 1, according to a preferred embodiment of the present invention. Conformal inwardly turned edge 1102 assists in fastening the ruggedizer 104 to the ear cup at lip 604. Conformal inwardly turned edge 1102 is illustrated to have uniform width, but that is not a limitation of the invention. Likewise, lip 604 may have varying extension in some embodiments and may be discontinuous some embodiments. Ruggedizers 102 and 104 each have a headgear opening 1104 for enabling coupling between headgear 150 and earpieces 160 and 170.

The embodiments described above are merely exemplary. Such examples are limited only by the claims below in light of the specification above. Those of skill in the art, enlightened by the present disclosure, will understand the variety of ways that the inventive crux of the present invention may be implemented, all of which are within the scope of the present invention. For non-limiting example, a material other than silicone rubber, but having sufficiently similar properties, may be used as an equivalent material for making a ruggedizer.

We claim:

1. A ruggedizer, comprising:
a. a flexible and resilient releasable one-piece cover adapted to cover an ear cup of a communication headset; and
b. at least one portion of said cover having a shape conformal to a manual control actuator on said ear cup.

2. The ruggedizer of claim 1, comprising at least one opening adapted to be aligned to an access point on said ear cup.

3. The ruggedizer of claim 2, wherein:
a. said at least one opening adapted to be aligned to an access point on said ear cup comprises at least one of:
i. a strap opening;
ii. a forward-directed microphone opening;
iii. an indicator light opening;
iv. a DC charger port opening;
v. a base for a boom microphone;
vi. a headgear coupling opening; and
b. a groove manufactured into an interior surface of said ruggedizer adapted to delineate a cutting line for making an opening for connecting optional accessories.

4. The ruggedizer of claim 1, comprising a volume adapted to enable flotation for said headset.

5. The ruggedizer of claim 1, wherein said ear cup comprises an ear cup adapted to be coupled to a right side of a headband of said headset.

6. The ruggedizer of claim 5, wherein said ruggedizer is installed on said ear cup, wherein said ear cup comprises said ear cup coupled to said right side of said headband.

7. The ruggedizer of claim 1, wherein said ear cup comprises an ear cup adapted to be coupled to a left side of a headband of said headset.

8. The ruggedizer of claim 7, wherein said ruggedizer comprises said ruggedizer installed on said ear cup, wherein said ear cup comprises said ear cup coupled to said left side of said headband.

9. The ruggedizer of claim 1, wherein said at least one portion of said cover having a shape conformal to a manual control actuator on said ear cup comprises a conformal portions of said ruggedizer adapted to be aligned to at least one of:
a. a push to talk button;
b. a power ON/OFF switch;
c. a channel-up selector button;
d. a channel-down selector button;
e. a lower volume button;
f. a raise volume button;
g. an answer/menu button.

10. The ruggedizer of claim 1, wherein said ruggedizer comprises flexible conformal resilient material having a color that is at least one of:
a. black;
b. white;
c. a bright color;
d. a glow-in-the dark color;
e. a color emitted by electric lights adapted to emit through a translucent said ruggedizer;
f. a colored translucent said ruggedizer adapted to be illuminated by electric lights adapted to emit through said colored translucent ruggedizer.

11. A ruggedizer, comprising:
a. at least one flexible and resilient releasable one-piece cover adapted to cover at least one ear cup of a communication headset;
b. at least one portion of said at least one cover having a shape conformal to at least one manual control actuator on said at least one ear cup; and
c. at least one opening adapted to be aligned to at least one access point on said at least one ear cup.

12. The ruggedizer of claim 11, comprising a volume sufficient to enable flotation for said headset.

13. The ruggedizer of claim 11, comprising silicone rubber having a color that is at least one of:
a. black;
b. white;
c. a bright color;
d. a glow-in-the dark color;
e. a color emitted by electric lights adapted to emit through a translucent said ruggedizer;
f. a colored translucent said ruggedizer adapted to be illuminated by electric lights adapted to emit through said colored translucent ruggedizer.

14. The ruggedizer of claim 11, wherein said at least one ear cup comprises:
a. a first said ear cup adapted to be coupled to a right side of a headband of said headset; and
b. a second said ear cup adapted to be coupled to a left side of said headband of said headset.

15. The ruggedizer of claim 14, wherein said at least one ruggedizer comprises:
a. a first said ruggedizer of said at least one ruggedizer installed on said first ear cup; and
b. a second said ruggedizer of said at least one ruggedizer installed on said second ear cup.

16. The ruggedizer of claim 15, wherein said at least one ruggedizer comprises:
a. said first ear cup coupled to said right side of said headband; and
b. said second ear cup coupled to said second side of said headband.

17. The ruggedizer of claim 11, wherein:
a. said at least one opening adapted to be aligned to at least one access point on said at least one ear cup comprises at least one of:
i. a strap opening;
ii. a forward-directed microphone opening;
iii. an indicator light opening;
iv. a DC charger port opening;
v. a base for a boom microphone; and
vi. a headgear coupling opening;
b. a groove manufactured into an interior surface of said ruggedizer is adapted to delineate a cutting line for making an opening for connecting at least one optional accessory; and
c. said at least one portion of said cover having a shape conformal to at least one manual control actuator on said at least one ear cup comprises at least one conformal portion of said at least one ruggedizer adapted to be aligned to at least one of:
i. a push to talk button;
ii. a power ON/OFF switch;
iii. a channel-up selector button;
iv. a channel-down selector button;
v. a lower volume button;
vi. a raise volume button;
vii. an answer/menu button.

18. A ruggedizer, comprising:
a. at least one flexible and resilient releasable one-piece cover adapted to cover at least one ear cup of a communication headset;
b. at least one portion of said at least one cover:
i. comprising a shape conformal to at least one manual control actuator on said at least one ear cup; and
ii. adapted to be aligned to at least one manual control on said at least one ear cup;
c. at least one opening adapted to be aligned to at least one access point on said at least one ear cup;
d. flexible conformal resilient material having a color that is at least one of:
i. black;
ii. white;
iii. a bright color;
iv. a glow-in-the dark color;
v. a color emitted by electric lights adapted to emit through a translucent said ruggedizer; and
vi. a colored translucent said ruggedizer adapted to be illuminated by electric lights adapted to emit through said colored translucent ruggedizer.

19. The ruggedizer of claim 18, wherein said at least one ear cup comprises:
a. a first said ear cup adapted to be coupled on a right side of said headset having installed thereon a first said ruggedizer, wherein said first ear cup is coupled to said right side of said headset; and
b. a second said ear cup adapted to be coupled on a left side of said headset having installed thereon a second said ruggedizer, wherein said second ear cup is coupled to said left side of said headset.

20. The ruggedizer of claim 18, comprising:
a. said at least one opening adapted to be aligned to at least one access point on said at least one ear cup further comprises at least one of:
i. a strap opening;
ii. a forward-directed microphone opening;
iii. an indicator light opening;
iv. a DC charger port opening;
v. a base for a boom microphone; and
vi. a headgear coupling opening.
b. a groove manufactured into an interior surface of said ruggedizer adapted to delineate a cutting line adapted for making an opening adapted for connecting optional accessories; and
c. said at least one portion of said cover having a shape conformal to at least one manual control actuator on said at least one ear cup comprises at least one conformal portion of said at least one ruggedizer adapted to be aligned to at least one of:
i. a push to talk button;
ii. a power ON/OFF switch;
iii. a channel-up selector button;
iv. a channel-down selector button;
v. a lower volume button;
vi. a raise volume button; and
vii. an answer/menu button.
